(19) United States
(12) Patent Application Publication
(10) Pub. No.: US 2012/0026179 A1
(43) Pub. Date: Feb. 2, 2012

(54) IMAGE PROCESSING DIVISION

(75) Inventor: Noriyuki FUNAKUBO, Hamamatsu-shi (JP)

(73) Assignee: YAMAHA CORPORATION, Hamamatsu-shi (JP)

(21) Appl. No.: 13/193,044

(22) Filed: Jul. 28, 2011

(30) Foreign Application Priority Data
Jul. 28, 2010 (JP) 2010-169823

(51) Int. Cl. G06F 13/00

(52) U.S. Cl. 345/536

(57) ABSTRACT

In an image processing device, an image data generation unit generates image data of an object to be displayed on a display device in each vertical scan period. A memory management unit manages a working memory for storing the image data generated by the image data generation unit. The memory management unit selects a storage region of the working memory for storing image data when the same is generated and stores the generated image data in the selected storage region, and releases another storage region which stores image data that has been used for display on the display device, thereby allowing said another storage to store new image data. A drawing unit reads image data required to draw one line on the display device in each horizontal scan period from the working memory through the memory management unit, then generates the image data of one line based on the read image data, and stores the generated image data of one line in a line buffer. A controller sequentially instructs the image data generation unit to generate image data of each object before image data of each object is displayed on the display device in each vertical scan period.

### BACKGROUND OF THE INVENTION

1. Technical Field of the Invention

The present invention relates to an image processing device that draws image data and displays the image data on a display device using a line buffer having a storage capacity corresponding to one line of a screen of the display.

2. Description of the Related Art

As is well known, a drawing process in which image data of a still image or a moving image is written to a buffer and a display process in which image data in the buffer is read and displayed on a display device are simultaneously performed in parallel to each other in an entertainment device such as a game console. Examples of the image processing device that performs the drawing process and the display process in this manner include a frame buffer based image processing device using a frame buffer that stores image data corresponding to one frame and a line buffer based image processing device using a line buffer that stores image data corresponding to one line. One example of a document regarding the line buffer based image processing device is Japanese Patent Application Publication No. 2005-215252.

In the frame buffer based image processing device, for example, image data corresponding to one frame is generated and stored in a frame buffer in one vertical scan period. In this type of frame buffer based image processing device, it is possible to generate image data of an object (i.e., an image to be displayed) by decoding compressed data obtained, for example, through a high compression algorithm such as a Joint Photographic Experts Group (JPEG) algorithm in one vertical scan period, and it is also possible to achieve display of high resolution and full color images on a display device. However, this type of frame buffer based image processing device requires a large-capacity frame buffer. A Dynamic Random Access Memory (DRAM) is generally used as the frame buffer. Therefore, data stored in the DRAM used as a frame buffer may be lost due to the influence of noise, thereby disturbing a screen of the device. In addition, the frame buffer based image processing device is expensive since it requires a high-capacity frame buffer.

On the other hand, the line buffer based image processing device only needs to have a small-capacity memory and does not require a high-capacity DRAM. Therefore, noise hardly disturbs the screen. The line buffer based image processing device may be implemented at a low price since it does not require a high-capacity frame buffer. However, in the line buffer based image processing device, image data to be displayed in a next horizontal scan period should be generated and written to the line buffer within one horizontal scan period. It is difficult to generate image data corresponding to one line to be displayed from compressed data obtained, for example, through a high-compression JPEG algorithm and write the image data to the line buffer within such a short time. Therefore, in a conventional line buffer based image processing device, uncompressed image data or image data obtained through a low-compression algorithm which can be decoded in units of lines such as a differential coding algorithm is stored in a Read Only Memory (ROM), and image data corresponding to one line to be displayed is generated based on the image data stored in the ROM and the generated image data is written to the line buffer. Here, it is difficult to increase the amount of data that is read from the ROM within one horizontal scan period since the ROM generally has a low read speed. In addition, it is difficult to increase the amount of image data that is generated to be displayed within one horizontal scan period since the image data stored in the ROM is uncompressed or slightly compressed image data as described above. Therefore, it is difficult to perform full color and high resolution image display in the conventional line buffer based image processing device.

### SUMMARY OF THE INVENTION

The invention has been made in view of the above circumstances, and it is an object of the invention to provide a technical means for achieving full color and high resolution image display in a line buffer based image processing device.

The invention provides an image processing device comprising: a line buffer that stores image data of one line which is drawn in synchronization with a horizontal synchronization signal; a working memory having a plurality of storage regions for use in processing of image data; an image data generation unit that generates image data of an object to be displayed on a display device in each vertical scan period; a memory management unit that manages the working memory to function as a virtual memory for storing the image data of an object generated by the image data generation unit, wherein the memory management unit selects a storage region of the working memory for storing image data of an object to be displayed when the image data of the object is generated and stores the generated image data in the selected storage region, and releases another storage region which stores image data that has been used for display on the display device among storage regions which store image data in the working memory, thereby allowing said another storage to store new image data; a drawing unit that reads image data required to draw one line in each horizontal scan period from the working memory through the memory management unit, then generates the image data of one line based on the read image data, and stores the generated image data of one line in the line buffer; and a controller that sequentially instructs the image data generation unit to generate image data of each object before image data of each object is displayed on the display device in each vertical scan period.

According to the invention, the controller sequentially instructs the image data generation unit to generate image data of each object before image data of each object is displayed on the display device in each vertical scan period. The image data generation unit generates the image data of the object according to the instruction and stores the generated image data in the working memory, which is a virtual memory, through the memory management unit. The drawing unit generates image data corresponding to one line that is to be displayed in each horizontal scan period based on the image data in the working memory. In addition, the memory management unit releases a storage region storing image data used for display among storage regions storing image data in the working memory in preparation for storage of new image data. Accordingly, the working memory only needs to have a small capacity. Since the period of generation of image data of an object by the image data generation unit is not limited within one horizontal scan period, it is possible to generate the image data of the object not only using uncompressed image data or slightly compressed image data which can be decoded on a line basis but also using highly compressed image data which cannot be decoded on a line basis. Therefore, the image processing device can implement high-resolution and full-color display even though the image processing device is of a line-buffer type.

### BRIEF DESCRIPTION OF THE DRAWINGS

FIG. 1 is a block diagram illustrating a configuration of an image display LSI which is an embodiment of an image processing device according to the invention;

FIG. 2 illustrates sprite attribute data stored in an attribute data storage unit in the embodiment;

FIG. 3 illustrates a relationship between a working memory and a management table in the embodiment;

FIG. 4 illustrates the performance sequence of image data generation processes that are performed on a plurality of objects in the embodiment;

FIG. 5 illustrates a performance schedule of the image data generation process for each object in the embodiment;

FIG. 6 illustrates a mode of parallel performance of a plurality of decoding processes in the embodiment; and

FIG. 7 illustrates a drawing process corresponding to one line performed in the embodiment.

### DETAILED DESCRIPTION OF THE INVENTION

Embodiments of the invention will now be described with reference to the drawings.

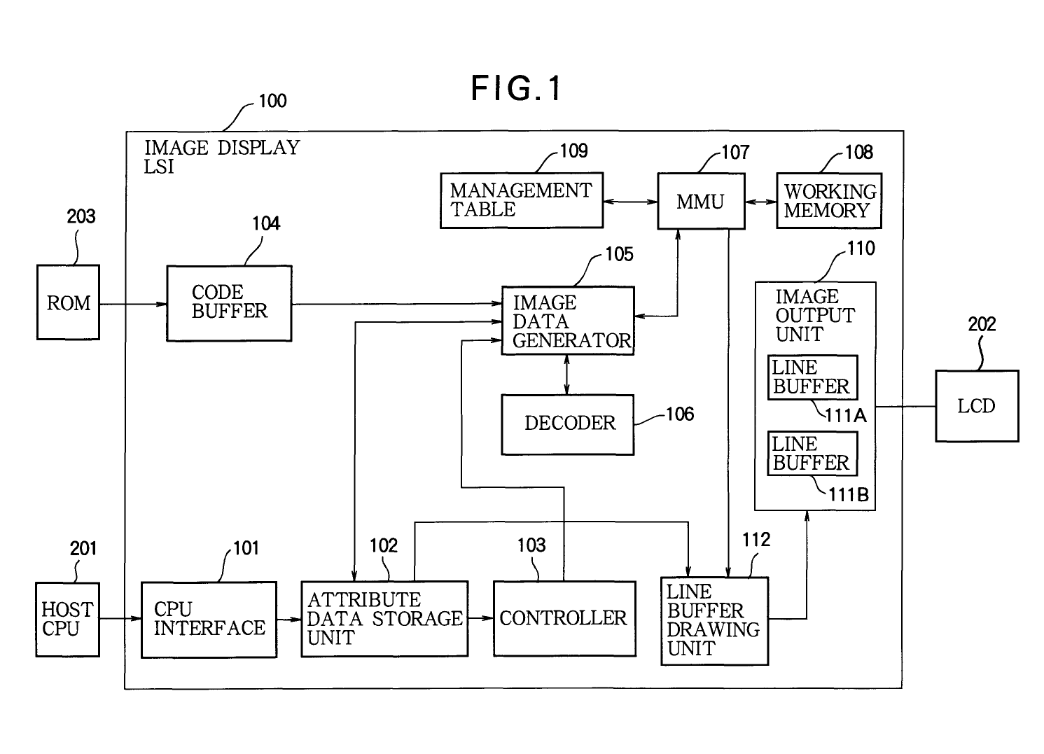

FIG. 1 is a block diagram illustrating a configuration of an entertainment device including an image display Large Scale Integrated Circuit (LSI) 100 which is an embodiment of an image processing device according to the invention. In FIG. 1, a host CPU 201, a Liquid Crystal Display (LCD) 202, and a ROM 203 connected to the image display LSI 100 are shown together with the image display LSI 100 for better understanding of functionality of the image display LSI 100. Among these components, the host CPU 201 is a processor for controlling overall operation of the entertainment device and provides the image display LSI 100 with commands and data for displaying an image such as a sprite or an outline font on the LCD 202. Compressed or uncompressed image data of objects (i.e., images to be displayed) such as various sprites and outline fonts, compressed or uncompressed alpha data used for alpha blending, and the like are stored in the ROM 203.

As shown in FIG. 1, the image display LSI 100 includes a CPU interface 101, an attribute data storage unit 102, a controller 103, a code buffer 104, an image data generator 105, a decoder 106, a Memory Management Unit (MMU) 107, a working memory 108 including a Static Random Access Memory (SRAM) or the like, a management table 109, an image output unit 110, and a line buffer drawing unit 112.

The CPU interface 101 is an interface that acquires a command and data provided from the host CPU 201 and provides the command and data to each relevant component in the image display LSI 100. The attribute data storage unit 102 is a circuit that stores attribute data provided from the CPU interface 101 through the host CPU 201. Here, the attribute data represents display attributes of each object such as a sprite or an outline font. In each vertical scan period, the host CPU 201 provides attribute data for each image to be displayed on the LCD 202, and the provided attribute data is stored in the attribute data storage unit 102 through the CPU interface 101.

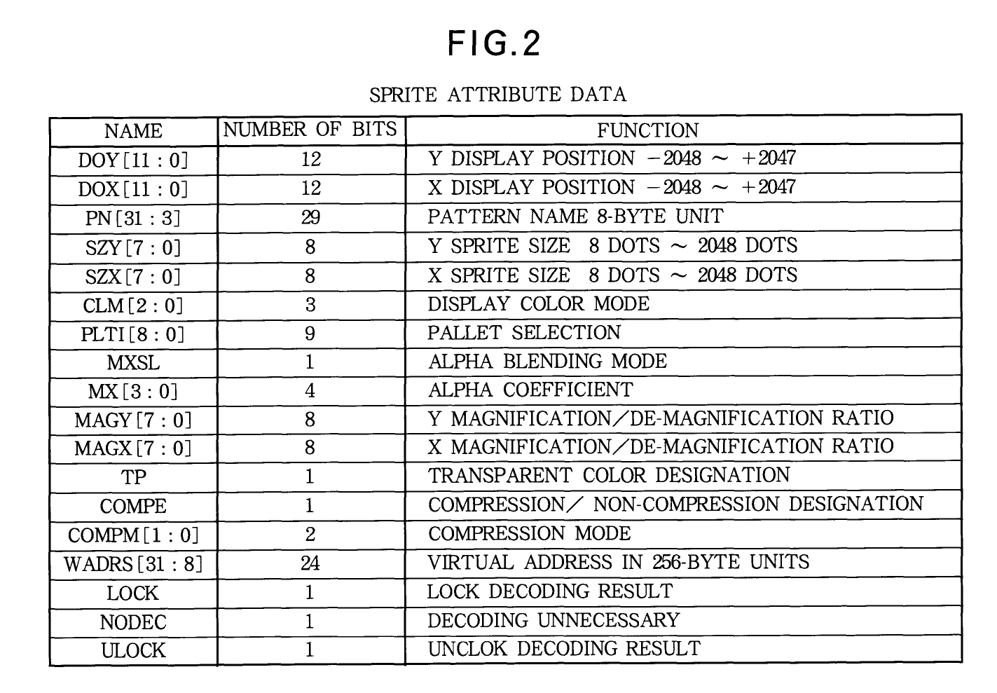

FIG. 2 illustrates sprite attribute data representing display attributes of a sprite as an example of such a type of attribute data. In this sprite attribute data, a Y display position DOY and an X display position DOX are data specifying a vertical display position and a horizontal display position of a left upper corner of the sprite on a screen of the LCD 202. A pattern name PN is a pattern name used to access image data of the sprite in the ROM 203. Specifically, the pattern name PN is a storage start address in the ROM 203 of the image data. A Y sprite size SZY and an X sprite size SZX represent the number of dots in a Y direction and the number of dots in an X direction of the sprite, respectively. A display color mode CLM and pallet selection data PLTI are used to calculate a display color of each constituent dot of the sprite. An alpha blending mode MXSL and an alpha coefficient MX are data specifying the type of alpha blending that is performed between a constituent dot of the sprite and a constituent dot of a background of the sprite. A Y magnification/demagnification ratio MAGY is a ratio of the number of dots in a Y direction of the sprite in the screen of the LCD 202 to the Y sprite size SZY of the sprite, and an X magnification/demagnification ratio MAGX is a ratio of the number of dots in an X direction of the sprite in the screen of the LCD 202 to the X sprite size SZX of the sprite. The vertical and horizontal positions of each constituent dot of the sprite in the screen of the LCD 202 can be calculated based on the Y magnification/de-magnification ratio MAGY, the X magnification/de-magnification ratio MAGX, the Y sprite size SZY, the X sprite size SZX, the Y display position DOY, and the X display position DOX.

The transparent color designation data TP is data specifying whether or not there is a dot treated as a transparent object in the sprite when the sprite is displayed. Compression/noncompression designation data COMPE is data indicating whether the image data of the sprite stored in the ROM 203 is compressed image data or noncompressed image data. A compression mode COMPM is data indicating a compression algorithm in the case where the image data of the sprite is compressed image data.

A virtual address WADRS is a virtual address that is initially generated among virtual addresses generated to identify image data of the sprite. A LOCK bit is a bit indicating whether or not to lock the image data of the sprite, i.e., a bit indicating whether or not to prohibit overwriting to a storage region of the working memory 108 in which the image data of the sprite is stored. A NODEC bit is a bit indicating whether or not a decoding process of the image data of the sprite is unnecessary. An ULOCK bit is a bit indicating whether or not to release the lock of the image data of the sprite.

Referring back to FIG. 1, the controller 103 is a circuit that sequentially instructs the image data generator 105 to generate image data of each object before displaying the image data of each object on the LCD 202 in each vertical scan period. Specifically, the controller 103 composes a schedule of performance of process for generating image data of each object based on attribute data of each object stored in the attribute data storage unit 102 in each vertical scan period, and provides an instruction to generate image data of each object to the image data generator 105 according to the performance schedule. In order to avoid redundant explanation, details of the contents of the performance schedule performed by the controller 103 will be clearly described in the description of the operation of this embodiment.

The image output unit 110 includes a pair of line buffers 111A and 111B, each having a sufficient capacity to store image data of one line. One of the line buffers 111A and 111B is operated as a write line buffer while the other is operated as a read line buffer in alternate manner. In synchronization with a horizontal synchronization signal of the LCD 202, one of the line buffers 111A and 111B, which has been a write line buffer until that time, is switched to a read line buffer and the other which has been a read line buffer is switched to a write line buffer. In each horizontal scan period, image data of one line that has been stored in the read line buffer is read while image data of one line that is to be displayed one horizontal scan period later (hereinafter referred to as a “to-be-displayed line”) is written to the write line buffer through the line buffer drawing unit 112. The line buffer drawing unit 112 will be described later.

The code buffer 104 is a buffer for temporarily storing compressed or noncompressed image data read from the ROM 203. In this embodiment, the code buffer 104 includes a plurality of buffer regions for primarily storing compressed data such as sprites since the decoder 106, which will be described later, may perform processes for decoding a plurality of compressed data such as a plurality of sprites through time division control.

The image data generator 105 is a circuit that performs an image data generation process in which image data of an object is generated according to an instruction to generate the image data of the object, received from the controller 103, using the decoder 106 and is then stored in the working memory 108 through the MMU 107.

More specifically, in the image data generation process, upon receiving an instruction to generate image data of an object (for example, a sprite) from the controller 103, the image data generator 105 refers to sprite attribute data of the sprite in the attribute data storage unit 102 and reads image data of the sprite from the ROM 203 using a pattern name PN in the sprite attribute data and stores the read image data of the sprite in the code buffer 104. Here, when compression/noncompression designation data COMPE of the sprite attribute data indicates that the image data of the sprite is compressed image data, the image data generator 105 notifies the decoder 106 of the compression/noncompression designation data COMPE of the sprite attribute data and also provides image data (compressed data in this case) in the code buffer 104 to the decoder 106 to allow the decoder 106 to perform a decoding process of the compressed data.

In this embodiment, after the decoder 106 starts a decoding process of compressed data of one sprite, the decoder 106 may receive an instruction to perform a decoding process of compressed data of another sprite before the decoding process of the compressed data of the one sprite is completed. To cope with such a need, the decoder 106 is configured to be able to perform decoding processes of a plurality of sprites in parallel through time division control. In this case, the compressed data of the plurality of sprites are stored in different buffer regions in the code buffer 104 as described above. The decoder 106 sequentially reads the compressed data of the sprites from the buffer regions and performs decoding processes of the compressed data of the sprites.

In the image data generation process, image data of each sprite obtained through such a decoding process is divided into image data divisions, each having an amount of data corresponding to one-page storage capacity of the working memory 108 that will be described later and a virtual address is generated for each of the image data divisions.

Various methods may be employed for virtual address generation. In a preferred method, a virtual address is generated for each dot included in a sprite obtained through the decoding process. For example, a higher address part of a virtual address of each dot included in the sprite is determined based on a pattern name of the sprite and a middle address part and a lower address part of the virtual address of each dot included in the sprite are determined based on a Y address and an X address in the sprite of each dot included in the sprite. In the case where raster scan of each dot in the sprite has been performed, the virtual address of each dot is determined such that the virtual address of each dot increases in increments of 1 LSB in the raster scan order. Then, in the case where the image data of the sprite is divided into a plurality of pages, the virtual address of a dot stored in an initial area of each page is determined to be a virtual address corresponding to the page.

In the image data generation process, the virtual addresses and the image data generated in the above manner are provided to the MMU 107 and are then stored in the working memory 108. In addition, in the image data generation process, the first of the virtual addresses generated for the image data of the sprite (for example, a virtual address of a dot at the left upper corner of the sprite) is stored in the attribute data storage unit 102 as a virtual address WADRS which is a part of the sprite attribute data.

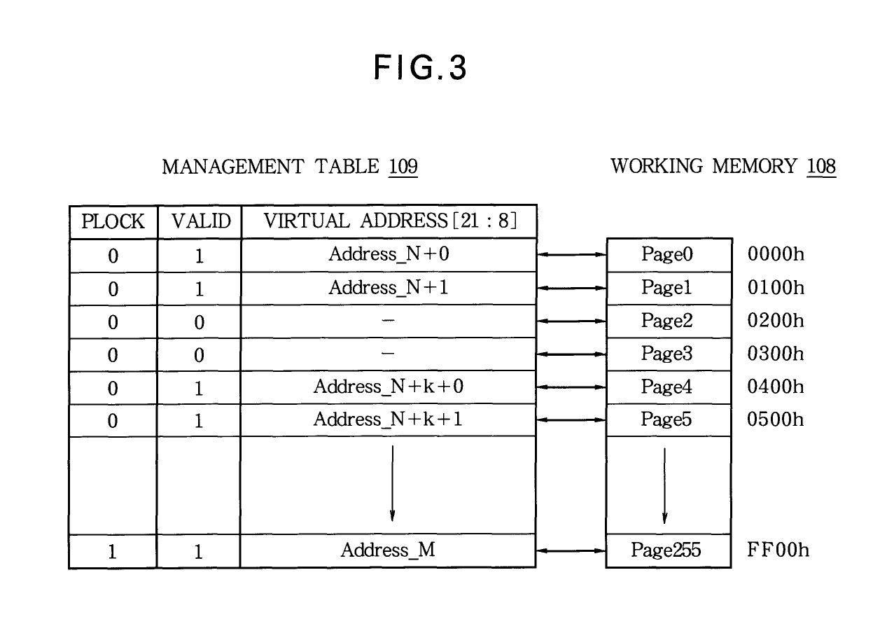

The MMU 107, the working memory 108, and the management table 109 constitute a virtual memory system. FIG. 3 illustrates a relationship between the working memory 108 and the management table 109. As shown in FIG. 3, an actual address space of the working memory 108 is divided into pages, each having a specific capacity of, for example, 256 bytes. The management table 109 is a table in which, for each page of the working memory 108, a virtual address of image data stored in the page, a PLOCK bit indicating whether or not to lock data of the page, i.e., a bit indicating whether or not to prohibit overwriting to the data of the page, and a VALID bit indicating whether or not valid image data has been stored in the page are registered in association with the corresponding page of the working memory 108. Here, the PLOCK bit corresponding to each page is set to “1” when the data of the page is locked and is set to “0” when the data of the page is not locked. The VALID bit corresponding to each page is set to “1” when the data of the page is valid and is set to “0” when the data of the page is invalid.

Returning again to FIG. 1, when the MMU 107 has acquired image data and virtual addresses of a sprite from the image data generator 105, the MMU 107 searches the working memory 108 for a page, whose VALID bit is “0” in the management table 109, and determines the found page to be a write destination of the image data. Then, the MMU 107 refers to a LOCK bit of attribute data corresponding to the sprite in the attribute data storage unit 102 and sets a PLOCK bit corresponding to the write destination page of the image data of the sprite to “0” if the LOCK bit of the sprite is “0” and sets the PLOCK bit “1” if the LOCK bit of the sprite is “1”. Then, the MMU 107 starts writing the image data of the sprite to the write destination page and sets the VALID bit to “1” when writing is completed.

In the case where image data of a page whose VALID bit is “1” in the management table 109 has been used up for display after being read through a drawing process that will be described later, the MMU 107 updates the VALID bit. That is, the MMU 107 switches the VALID bit corresponding to the page to “0” when a PLOCK bit corresponding to the page is “0” in the management table 109 and keeps the VALID bit “1” corresponding to the page unchanged when the PLOCK bit is 1″.

The line buffer drawing unit 112 is a means for performing a drawing process in which image data of one line that is to be displayed on the LCD 202 in a next horizontal scan period is generated and the image data of one line is written to a write line buffer of the image output unit 110 in each horizontal scan period.

In the drawing process, the line buffer drawing unit 112 searches for each object (for example, each sprite), which a to-be-displayed line horizontally crosses, by referring to each piece of attribute data in the attribute data storage unit 102, and reads image data of each found sprite corresponding to one line, which occupies the to-be-displayed line among image data of each found sprite, from the working memory 108 through the MMU 107.

Here, in some cases, the object may correspond to magnification (expansion) or de-magnification (contraction) of a sprite. In this case, it is assumed that a magnification/demagnification process has been performed on the image data according to a Y magnification/de-magnification ratio MAGY and an X magnification/de-magnification ratio MAGX of the sprite attribute data of the sprite, i.e., the image data is image data of a sprite having a Y-direction size of SZY*MAGY (*: multiplication) and an X-direction size of SZX*MAGX. A virtual address of image data (i.e., image data on two adjacent lines sandwiching the to-be-displayed line after magnification/demagnification of the sprite) used for bilinear filtering for acquiring image data that occupies the to-be-displayed line in the image data is calculated, and image data corresponding to the virtual address is read from the working memory 108 through the MMU 107 to calculate the image data that occupies the to-be-displayed line.

In the drawing process, image data corresponding to one line of each sprite generated based on data read from the working memory 108 while performing alpha blending between each sprite as needed is combined sequentially in the order of arrangement of sprite attribute data of each sprite in the attribute data storage unit 102 to generate composite image data of the to-be-displayed line. This operation is performed using the write buffer of the image output unit 110.

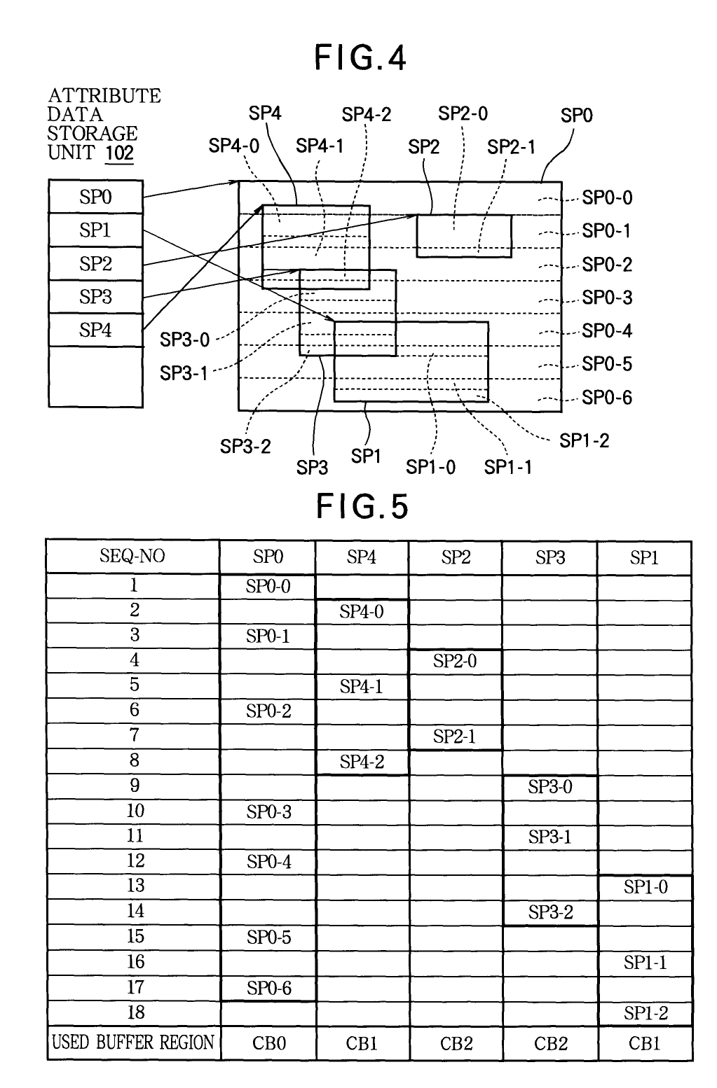

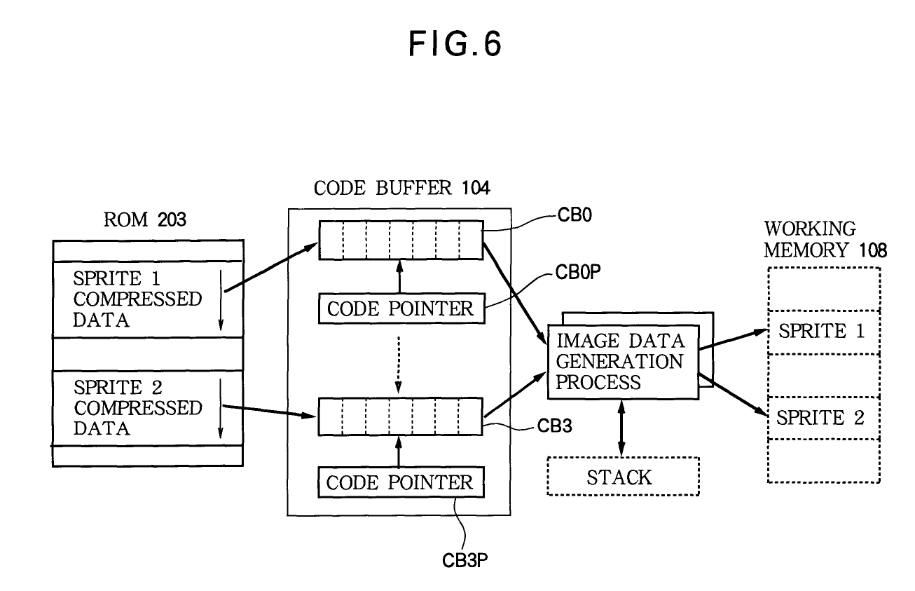

FIG. 4 illustrates the performance sequence of image data generation processes that are performed on a plurality of sprites in this embodiment. FIG. 5 illustrates a performance schedule of the image data generation process for each sprite shown in FIG. 4. FIG. 6 illustrates a mode of parallel performance of a plurality of decoding processes in this embodiment. Operation of this embodiment will now be described with reference to these drawings.

Here, let us assume that, in a vertical scan period, sprite attribute data of sprites SP0 to SP4 have been stored in the attribute data storage unit 102 as shown in the left side of FIG. 4. In this case, the controller 103 obtains occupied regions in the screen of the LCD 202 when image data of the sprites SP0 to SP4 are displayed as they are on the LCD 202 based on a Y sprite size SZY and an X sprite size SZX and a Y display position DOY and an X display position DOX of each sprite attribute data (after the image data is subjected to a decoding process and is not subjected to a magnification/demagnification process). The resulting screen is shown in the right side of FIG. 4.

The controller 103 divides each sprite into raster blocks, each including a predetermined number of lines, and generates a performance schedule of an image data generation process of each raster block. More specifically, the controller 103 obtains a position of each raster block in the screen. In the example illustrated in the right side of FIG. 4, the sprite SP0 is a background image that occupies the entire region of the screen of the LCD 202 and is divided into raster blocks SP0-0 to SP0-6. In addition, the sprite SP1 is divided into raster blocks SP1-0 to SP1-2, the sprite SP2 is divided into raster blocks SP2-0 and SP2-1, the sprite SP3 is divided into raster blocks SP3-0 to SP3-2, and the sprite SP4 is divided into raster blocks SP4-0 to SP4-2.

Then, the controller 103 searches the screen for raster blocks in a direction from the top of the screen to the bottom. In this case, by searching the screen from the top to the bottom, the controller 103 finds raster blocks in the order of SP0-0->SP4-0->SP0-1->SP2-0->SP4-1-> . . . ->SP0-6->SP1-2. Thus, the controller arranges a performance schedule specifying that image data generation processes of the raster blocks are to be performed in the order in which the controller has found the raster blocks while searching the screen from the top to the bottom. The composed performance schedule is shown in FIG. 5.

As described above, the decoder 106 provides the image data generation unit 105 with of a plurality of objects SP0-SP4 which are contained in a frame to be displayed on the display device 202 in a vertical scan period. The image data generation unit 105 divides each object SP into raster blocks, each including a predetermined number of lines. The controller 103 controls the image data generation unit 105 to sequentially generate the image data of the raster blocks of the objects SP in a vertical scan period in order of positions of the respective raster blocks of the objects from top to bottom of the frame.

In FIG. 5, SEQ_NO is the sequence number of performance of an image data generation process of each raster block. In the example of FIG. 4, a top line of the raster block SP0-1 and a top line of the raster block SP2-0 are at the same vertical position in the screen. However, sprite attribute data of the sprite SP0 to which the raster block SP0-1 belongs is stored at an address prior to sprite attribute data of the sprite SP2, to which the raster block SP2-0 belongs, in the attribute data storage unit 102. Therefore, when the line buffer drawing unit 112 generates image data of a to-be-displayed line which horizontally crosses the raster block SP0-1 and the raster block SP2-0, first, the line buffer drawing unit 112 reads image data of the to-be-displayed line in the raster block SP0-1 from the working memory 108 and writes the read image data to the write line buffer of the image output unit 110, and then reads image data of the to-be-displayed line in the raster block SP2-0 from the working memory 108 and writes the read image data to the write line buffer of the image output unit 110. Thus, since image data of the raster block SP0-1 is used before image data of the raster block SP2-0 in the drawing process, the sequence number “SEQ_NO” of the raster block SP0-1 is 3 and “SEQ_NO” of the raster block SP2-0 is 4 in the performance schedule shown in FIG. 5. Other simultaneously found raster blocks are handled in the same manner.

The controller 103 sequentially transmits, to the image data generator 105, instructions to perform image data generation processes starting from an image data generation process of the raster block SP0-0, which is scheduled at SEQ_NO=1 in the performance schedule obtained in the above manner, and ending with an image data generation process of the raster block SP1-2 scheduled at SEQ_NO=18. Here, the controller 103 advances the output timing of the instruction to perform the image data generation process of each raster block with respect to the display timing of the raster block by a predetermined marginal time so as to display each raster block on the LCD 202 on time.

Upon receiving a performance instruction, the image data generator 105 performs an image data generation process, which includes a decoding process performed through the decoder 106, on a raster block indicated by the instruction. In this case, there may be a case in which, when the image data generator 105 has received an instruction to perform an image data generation process on an initial raster block of a sprite, an image data generation process of all raster blocks of another sprite, which was previously initiated, has not been completed. In this case, the image data generator 105 performs image data generation processes of a plurality of sprites in parallel through time division control. FIG. 6 illustrates how image data generation processes are performed in parallel in this case.

In this embodiment, compressed data of sprites is acquired by the code buffer 104 on a sprite basis and an image data generation process of each sprite (including a decoding process) is performed on a raster block basis while switching raster blocks. The following is a more detailed description of this process.

First, upon receiving an instruction to perform an image data generation process of an initial (or first) raster block of a sprite (for example, the sprite 1), the image data generator 105 instructs the code buffer 104 to acquire compressed data of the sprite 1. According to this instruction, the code buffer 104 reads the compressed data of the sprite 1 from the ROM 203 and stores the read compressed data in a buffer region (for example, a buffer region CB0) that is empty at that time. The image data generator 105 then starts an image data generation process of the initial raster block of the sprite 1. In this image data generation process, the decoder 106 reads compressed data from the buffer region CB0 of the code buffer 104 and performs decoding on the read compressed data to generate image data of the initial raster block of the sprite 1. The image data generator 105 transmits the image data generated by the decoder 106 and virtual addresses generated for the image data to the MMU 107, which then stores the image data and virtual addresses in the working memory 108. In this case, the MMU 107 selects, in the raster scan order, image data of each pixel of a rectangular region (which is obtained by dividing the raster block according to a page capacity) from the image data generator 105 and sequentially stores the selected image data, for example, in consecutive storage regions in the page. In the meantime, a code pointer CB0P provided for the buffer region CB0 in the code buffer 104 counts compressed data items, which have been read and used for a decoding process by the decoder 106, among compressed data items in the buffer region CB0. That is, the code pointer CB0P determines the sequence number of the last of the compressed data items which have been read and used for a decoding process.

Next, let us assume that, while the image data generator 105 performs an image data generation process of the initial raster block of the sprite 1, another instruction to perform an image data generation process of an initial raster block of another sprite (for example, the sprite 2) has been provided to the image data generator 105. In this case, the image data generator 105 instructs the code buffer 104 to acquire compressed data of the sprite 2. According to this instruction, the code buffer 104 reads the compressed data of the sprite 2 from the ROM 203 and stores the read compressed data in a buffer region (for example, a buffer region CB3) that is empty at that time. The image data generator 105 waits until the image data generation process of the initial raster block of the sprite 1 is completed and then starts an image data generation process of the initial raster block of the sprite 2. Here, the image data generator 105 saves a processing result of the image data generation process of the initial raster block of the sprite 1 in a stack since the processing result is needed, for example, for a decoding process of a subsequent raster block of the sprite 1.

Then, in a newly started image data generation process, the decoder 106 reads compressed data from the buffer region CB3 of the code buffer 104 and performs decoding on the read compressed data to generate image data of the initial raster block of the sprite 2. The image data generator 105 transmits the image data generated by the decoder 106 and virtual addresses generated for the image data to the MMU 107, which then stores the image data and virtual addresses in the working memory 108. In the meantime, a code pointer CB3P provided for the buffer region CB3 in the code buffer 104 counts compressed data items, which have been read and used for a decoding process by the decoder 106, among compressed data items in the buffer region CB3. That is, the code pointer CB3P determines the sequence number of the last of the compressed data items which have been read and used for a decoding process.

Thereafter, let us assume that, while the image data generator 105 performs an image data generation process of the initial raster block of the sprite 2, an instruction to perform an image data generation process of a second raster block of the sprite 1 has been provided to the image data generator 105. In this case, the image data generator 105 waits until the image data generation process of the initial raster block of the sprite 2 is completed and then starts an image data generation process of the second raster block of the sprite 1. Then, the image data generator 105 acquires the processing result saved in the stack and performs an image data generation process of a second raster block of the sprite 1.

Then, in this image data generation process, the decoder 106 resumes reading of compressed data from a position indicated by the code pointer CB0P of the buffer region CB0 and performs decoding on the read compressed data to generate image data of the second raster block of the sprite 1. The image data generator 105 transmits the image data generated by the decoder 106 and virtual addresses generated for the image data to the MMU 107, which then stores the image data and virtual addresses in the working memory 108. In the meantime, a code pointer CB0P provided for the buffer region CB0 in the code buffer 104 counts compressed data items, which have been read and used for a decoding process by the decoder 106, among compressed data items in the buffer region CB0. That is, the code pointer CB0P determines the sequence number of the last of the compressed data items which have been read and used for a decoding process. Thereafter, the same procedure is repeated each time an instruction to perform an image data generation process of a raster block is provided to the image data generator 105.

In this embodiment, compressed data of a sprite stored in each buffer region of the code buffer 104 is maintained until all compressed data of the sprite stored in the buffer region is read and a decoding process of the sprite is completed. Accordingly, the decoder 106 can perform, in parallel, decoding processes of compressed data of up to the same number of sprites as the buffer regions in the code buffer 104.

Buffer regions of the code buffer 104 used to store compressed data of each sprite are shown in FIG. 5 described above. In the example illustrated in FIG. 5, all compressed data of the sprite SP4 stored in the buffer region CB1 of the code buffer 104 have been read and image data generation processes (including decoding processes) of all raster blocks of the sprite SP4 has been completed when an instruction to generate image data of the initial raster block SP1-0 of the sprite SP1 (which corresponds to SEQ_NO=13) is generated. Therefore, when an instruction to perform an image data generation process of an initial raster block SP1-0 of the sprite SP1 is generated, compressed data of the sprite SP1 is input to a buffer region CB1 in the code buffer 104 which is empty at that time.

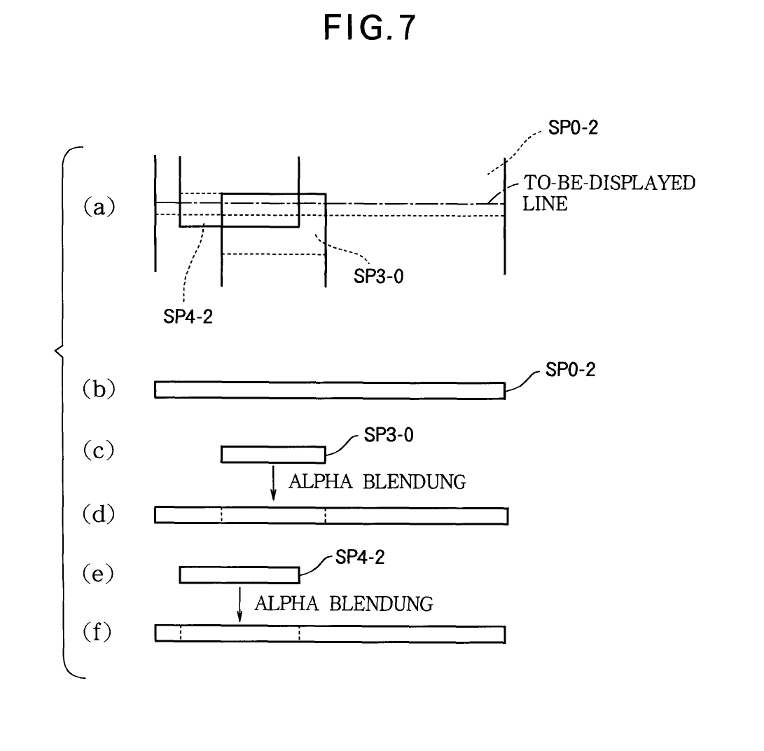

While the image data generation process described above is repeated, the line buffer drawing unit 112 repeats a process for drawing image data corresponding to one line in parallel with the image data generation process in synchronization with a horizontal synchronization signal. FIG. 7 illustrates how a drawing process corresponding to one line is performed.

First, in FIG. 7, part (a), a to-be-displayed line is present at a position which crosses the raster blocks SP4-2, SP3-0, and SP0-2 that have been subjected to the magnification/de-magnification process in the example of FIG. 4 described above. Here, in the case where sprite attribute data of each sprite is stored in the attribute data storage unit 102 as shown in the left side of FIG. 4, the line buffer drawing unit 112 determines that the image data of the raster block SP0-2 among the magnified/de-magnified raster blocks SP4-2, SP3-0, and SP0-2 which the to-be-displayed line crosses, the image data being image data corresponding to one line located at the to-be-displayed line, is the first image data to be generated (i.e., the first generation target). This is because the sprite attribute data of the sprites to which the raster blocks SP4-2, SP3-0, and SP0-2 belong have been stored in the attribute data storage unit 102 in the order of SP0->SP3->SP4 (see the left side of FIG. 4). The line buffer drawing unit 112 reads image data used to generate image data corresponding to one line present on a to-be-displayed line of the raster block SP0-2 from the working memory 108 through the MMU 107, performs a magnification/de-magnification process using the read data, generates image data corresponding to one line, and writes the generated image data to the write line buffer of the image output unit 110 (see FIG. 7, part (b)).

Then, the line buffer drawing unit 112 reads image data of the magnified/de-magnified raster block SP3-0, the image data being required to generate image data corresponding to one line located at the to-be-displayed line, from the working memory 108 through the MMU 107 (see FIG. 7, part (c)). In the case where alpha blending is specified to be performed in the sprite attribute data of the sprite SP3, alpha blending is performed using both image data of the to-be-displayed line which is part of the raster block SP3-0 and image data corresponding to one line which is part of the raster block SP0-2 stored in the write line buffer of the image output unit 110. Accordingly, the alpha-blended image data corresponding to one line remains in the write line buffer (see FIG. 7, part (d)).

Then, the line buffer drawing unit 112 reads image data of the magnified/de-magnified raster block SP4-2, the image data being required to generate image data corresponding to one line located at the to-be-displayed line, from the working memory 108 through the MMU 107 (see FIG. 7, part (e)). In the case where alpha blending is specified to be performed in the sprite attribute data of the sprite SP4, alpha blending is performed using both image data of the to-be-displayed line which is part of the raster block SP4-2 and image data corresponding to one line stored in the write line buffer of the image output unit 110. Accordingly, the alpha-blended image data corresponding to one line remains in the write line buffer (see FIG. 7, part (f)).

In the above manner, image data corresponding to one line to be displayed on the to-be-displayed line is completed and stored in the write buffer. Then, when the horizontal scan period is advanced, the write buffer is switched to a read buffer and the image data corresponding to one line that has been stored in the read buffer is read from the read buffer and provided to the LCD 202 and is then displayed on the screen of the LCD 202.

While the line buffer drawing unit 112 repeats the drawing process corresponding to one line described above in synchronization with a horizontal synchronization signal, the MMU 107 monitors read states of image data of each page of the working memory 108. In the case where last image data stored in a page has been read and used for a drawing process corresponding to one line, in principle, the MMU 107 sets a VALID bit that is associated with the page to “0” in the management table 109 and releases the page in preparation for storage of other image data. Through such a page release operation, it is possible to prevent all pages of the working memory 108 from being filled. Accordingly, it is possible to store image data used for a drawing process using the small-capacity working memory 108.

As described above, the memory management unit 107 stores the image data of the objects in a plurality of pages corresponding to the plurality of storage regions of the working memory 108. The drawing unit 112 reads image data of each line from the pages of the working memory 108 in each horizontal scan period through the memory management unit 107. The memory management unit 107 monitors each page while the drawing unit 112 reads the image of each line and releases the page when it is determined that the image data of all lines contained in the page have been read.

Although the above description has been given focusing on sprite display, the same is true for outline font display. In this embodiment, the controller 103 sequentially instructs the image data generator 105 to generate image data of each object, before image data of each object is displayed on the LCD 202, in each vertical scan period, and the image data generator 105 generates image data of the instructed object and stores the generated image data in the working memory 108, which is a virtual memory, through the MMU 107. On the other hand, the line buffer drawing unit 112 generates image data corresponding to one line that is to be displayed in each horizontal scan period based on the image data in the working memory 108. In addition, the MMU 107 releases a page storing image data used for display among pages storing image data in the working memory 108 in preparation for storage of new image data. Accordingly, the working memory 108 only needs to have a small capacity. Since the period of generation of image data of an object by the image data generator 105 is not limited within one horizontal scan period, it is possible to generate the image data of the object not only using noncompressed image data or slightly compressed image data which can be decoded on a line basis but also using highly compressed image data which cannot be decoded on a line basis. Thus, in this embodiment, there is an advantage in that the image processing device can implement high-resolution and full-color display even though the image processing device is of a line-buffer type.

Although one embodiment of the invention has been described above, other embodiments may also be provided according to the invention. The following are examples.

(1) It is possible to consider a case in which a plurality of attribute data are written to the attribute data storage unit 102 for the same sprite. For example, there may be a case in which the same sprite (for example, the sprite SP) is displayed at a plurality of display positions (for example, display positions P1 and P2). The following two schemes may be employed as a method to cope with such a case.

In the first scheme, the controller 103 causes the image data generator 105 to generate image data of the same two sprites SP and stores the image data of the sprites SP in the working memory 108 through the MMU 107. In the second scheme, the controller 103 causes the image data generator 105 to generate image data of one sprite SP and stores the image data of the sprite in the working memory 108 through the MMU 107.

In the first scheme, in the case where a LOCK bit of attribute data is set to “1” only for a sprite SP whose display position is P1, only a PLOCK bit of a page storing image data of the sprite whose display position is P1 is set to “1” while a PLOCK bit of a page storing image data of a sprite whose display position is P2 is set to “0”. In this case, the page whose PLOCK bit is “0” is released at the time when the image data stored in the page is used for display, whereas the page whose PLOCK bit is “1” is not released even when the image data stored in the page has been used for display. Accordingly, although image data of two sprites SP may be temporarily stored in the working memory 108, a page in which image data of one of the sprites SP has been stored is released at the time when the image data of the one sprite SP is used for display and therefore it is possible to reduce storage capacity required for the decoder 106.

In the second scheme, for example, in the case where the LOCK bit of attribute data has been set to “1” only for the sprite SP whose display position is P1, there is a need to set the PLOCK bit of the page storing image data of the sprite SP to “1” until the LOCK bit becomes “0”. Accordingly, update control of the PLOCK bit is a little complex. However, in the second scheme, in the case where image data of the same type of sprites SP is displayed at a plurality of positions, image data of only one sprite SP needs to be stored in the working memory 108 and thus it is possible to save storage capacity of the working memory 108.

(2) The virtual address generation method is not limited to that of the above embodiment. For example, in the case where image data of a sprite is divided into a plurality of pages and the plurality of pages are stored in the working memory 108, virtual addresses that are associated with pages storing parts of the image data of the same sprite may be consecutive virtual addresses. In summary, when the line buffer drawing unit 112 generates image data of a sprite present on a to-be-displayed line, the line buffer drawing unit 112 only needs to be able to obtain a virtual address associated with a page storing image data used to generate the image data of the sprite by referring to attribute data in the attribute data storage unit 102.

(3) In the above embodiment, when all image data of a page whose PLOCK bit is “0” and whose VALID bit is “1” has been used for display on the LCD 202, the MMU 107 sets the VALID bit corresponding to the page to “0” to release the page in preparation for storage of other image data. However, alternatively, the MMU 107 may set the VALID bit corresponding to the page whose PLOCK bit is “0” to “0” each time display of one frame is terminated.

(4) In the above embodiment, the controller 103 generates a performance schedule of an image data generation process of each raster block based on the display position of each raster block, which has not been subjected to magnification/de-magnification, in order to reduce load of the controller 103. However, when the controller 103 has sufficient calculation capabilities, the controller 103 may obtain a display position of each raster block that has been magnified/de-magnified with reference to a magnification/demagnification ratio of a sprite in the attribute data storage unit 102 and then generate a performance schedule of an image data generation process of each raster block based on the display position of each raster block that has been magnified/de-magnified.

What is claimed is:

1. An image processing device comprising:
a line buffer that stores image data of one line which is drawn in synchronization with a horizontal synchronization signal;
a working memory having a plurality of storage regions for use in processing of image data;
an image data generation unit that generates image data of an object to be displayed on a display device in each vertical scan period;
a memory management unit that manages the working memory to function as a virtual memory for storing the image data of an object generated by the image data generation unit, wherein the memory management unit selects a storage region of the working memory for storing image data of an object to be displayed when the image data of the object is generated and stores the generated image data in the selected storage region, and releases another storage region which stores image data that has been used for display on the display device among storage regions which store image data in the working memory, thereby allowing said another storage to store new image data;
a drawing unit that reads image data required to draw one line in each horizontal scan period from the working memory through the memory management unit, then generates the image data of one line based on the read image data, and stores the generated image data of one line in the line buffer; and
a controller that sequentially instructs the image data generation unit to generate image data of each object before image data of each object is displayed on the display device in each vertical scan period.

2. The image processing device according to claim 1, further comprising a decoder that reads compressed image data of an object from a storage medium, then decodes the compressed image data, and provides the decoded image data of the object to the image data generation unit.

3. The image processing device according to claim 1,
wherein the image data generation unit divides an object into raster blocks, each including a predetermined number of lines, then generates image data of each raster block, and stores the generated image data in the working memory through the memory management unit, and
wherein the controller instructs the image data generation unit to generate image data of each object in units of raster blocks into which the object is divided.

4. The image processing device according to claim 2,
Wherein the decoder provides the image data generation unit with a plurality of objects which are contained in a frame to be displayed on the display device in a vertical scan period,
wherein the image data generation unit divides each object into raster blocks, each including a predetermined number of lines, and
wherein the controller controls the image data generation unit to sequentially generate the image data of the raster blocks of the objects in a vertical scan period in order of positions of the respective raster blocks of the objects from top to bottom of the frame.

5. The image processing device according to claim 1,
wherein the memory management unit stores the image data of the objects in a plurality of pages corresponding to the plurality of storage regions of the working memory,
wherein the drawing unit reads image data of each line from the pages of the working memory in each horizontal scan period through the memory management unit, and
wherein the memory management unit monitors each page while the drawing unit reads the image of each line and releases the page when it is determined that the image data of all lines contained in the page have been read.
